(19) United States
(12) Patent Application Publication
(10) Pub. No.: US 2016/0110686 A1
(43) Pub. Date: Apr. 21, 2016

(54) SYSTEM AND METHOD FOR PROVIDING QUALIFICATION INFORMATION

(71) Applicant: Adam Denno, Westwood, KS (US)

(72) Inventor: Adam Denno, Westwood, KS (US)

(21) Appl. No.: 14/705,412

(22) Filed: May 6, 2015

Related U.S. Application Data
(60) Provisional application No. 61/989,598, filed on May 7, 2014.

(51) Int. Cl. G06Q 10/10; G06Q 50/00

(52) U.S. Cl. CPC G06Q 10/103; G06Q 50/01

(57) ABSTRACT

A qualification system and method. An embodiment may include a network database having a plurality of records corresponding to a plurality registered users wherein the plurality of records include a user profile. An embodiment may further include a registration system being capable of creating the user profile for an unregistered user, wherein the user profile identifies at least a portion of the user profile as at least one of basic, public, and sensitive. A further embodiment may include a notification system configured to distribute a notification to at least one registered user, wherein the notification includes at least one of data updates, performance updates, and user selected information.

### CROSS-REFERENCE TO RELATED APPLICATIONS

The present application claims the benefit of provisional application Ser. No. 61/989,598 filed May 7, 2014, the teachings of which are hereby incorporated herein by reference.

### FIELD

The present disclosure relates generally to a system and method for providing qualification information, e.g. for vendors.

### BACKGROUND

There is a current need to consolidate qualification information in the construction and other industries. Current market solutions are fragmented and do not allow for a user driven open market selective search and data distribution ability. Additionally, current solutions limit the ability to integrate data into other systems currently in use.

In the construction industry, most current solutions are driven from the Owner, General Contractor, Construction Manager or payment management firms which are available only to users of those specific systems. As a result, many firms are required to complete several prequalification platforms each year, potentially resulting in unneeded costs due to duplication, missed job opportunities due to potential error, redundancy and omission.

### BRIEF DESCRIPTION OF THE DRAWINGS

Reference should be made to the following detailed description which should be read in conjunction with the following figures, wherein like numerals represent like parts.

FIG. 1 depicts a flow chart showing an example data flow for the systems and methods described in the present disclosure.

FIG. 2 depicts a flow chart showing an example method for updating inbox confirmations for the systems and methods described in the present disclosure.

FIG. 3 depicts a flow chart showing an example method for logging in, registering, and receiving alerts for the systems and methods described in the present disclosure.

FIG. 4 depicts a flow chart showing an example method for updating and managing existing relationships for the systems and methods described in the present disclosure.

FIG. 5 depicts a flow chart showing an example method for enrollment for the systems and methods described in the present disclosure.

FIG. 6 depicts a flow chart showing an example method of processing relationships for the systems and methods described in the present disclosure.

FIG. 7 depicts a flow chart showing an example method of managing partnerships for the systems and methods described in the present disclosure.

FIG. 8 depicts a flow chart showing an example method for confirming a relationship for the systems and methods described in the present disclosure.

FIG. 9 depicts a flow chart showing an example method for responding to an information update request for the systems and methods described in the present disclosure.

FIG. 10 depicts an example of a graphical user interface (“GUI”).

FIG. 11 depicts an example of GUI for providing a description of services offered to users.

FIG. 12 depicts an example GUI for account creation.

FIG. 13 depicts a chart of data that may be collected during account creation.

FIG. 14 depicts an example GUI for displaying the prequalification status.

FIG. 15 depicts an example GUI for data collection.

FIG. 16 depicts a flow chart showing an example method of data compilation and storage.

FIG. 17 depicts an example GUI for an inbox.

FIG. 18 depicts an example GUI for collecting a user's contact information.

FIG. 19 depicts an example GUI for selecting states where a user is licensed.

FIG. 20 depicts an example GUI for viewing and submitting bids for projects.

FIG. 21 depicts an example GUI for searching for companies.

FIG. 22 depicts various example GUIs for searching using various criteria.

FIG. 23 depicts an example GUI for searching and building a list of potential and current partners.

FIG. 24 depicts an example GUI displaying the result of a search for potential and current partners.

FIG. 25 depicts an example GUI for viewing a public profile of a potential or current partner.

FIG. 26 depicts an example GUI displaying partner information.

FIG. 27 depicts an example of data analysis tool output.

FIG. 28 depicts a diagram showing a method of packaging of information for distribution consistent with the systems and methods described in the present disclosure.

### DETAILED DESCRIPTION

The present disclosure is generally directed to a system and method to streamline underwriting, qualification and relationship processes. Primarily geared towards the construction industry (but equally applicable to other industries), this platform is intended to consolidate key business underwriting data while eliminating duplication, error, redundancy and omission. In addition, these solutions allow for selective distribution of sensitive data points into other complimentary technical systems which will allow members the ability to understand another member's operational, financial and partnership capabilities.

For simplicity, exemplary embodiments described herein will be described with reference to the construction industry. It is to be understood, however, that a system and method consistent with the present disclosure may be used in any industry where pre-qualification is useful. In the construction industry (and related firms) a system consistent with the present disclosure provides a scalable, easy to use centralized data aggregation and distribution underwriting platform. Such a system has resonating benefits for owners, contractors, subcontractors, banks, sureties and insurance carriers by allowing them to more easily and thoroughly examine the strengths and weaknesses of their potential partners. In an embodiment, in order to allow partners to successfully limit unnecessary exposure to potential default and fee erosion, an example system and method consistent with the present disclosure addresses the following: reduced redundancies in requirements based prequalification submittals; allow users to selectively submit certain secure pieces of data—through an acceptance invite model; maintain a viewable database for marketing and research; understand partner & client capabilities; allow varying levels of access within an organization; outsource qualification and data verification process to a dedicated operation; integrate and export data from a centralized data operation through data mapping and conversion into existing complimentary market platforms—such as firm and industry qualification, solicitation and regulation requirement solutions; use developed or unique underwriting metrics to enhance current underwriting processes; consistent delivery of information; track, record and communicate clients performance data; assist in the discovery and selection of qualified partners; and allow users to create a community of partners both externally and internally.

Advantageously, in one example of a system consistent with the present disclosure information is selectively distributed based on the discretion of the subcontractor partner. This example platform gathers an extensive amount of data that partners are able to manage and maintain in a centralized location, selectively distribute and track who has been granted access and when the last updates were given. This platform also serves as a communication tool where users can search companies in the platform based on: location, CSI code, performance ratings, open inquiries (i.e. project opportunities). Partners are also able to communicate directly within the platform, sending and receiving notifications, updates and responses to inquiries (i.e. material quotes, project award or decline notifications, search for competitive bond, banking, insurance rates . . . ). Users are also able to attach outside profiles, pictures, links to their profile for additional profile enhancement, allow for selective access of data for internal users: Marketing is able to access commonly required data to submit on projects, finance will have access to financial data to submit for annual review, owners can manage and maintain all aspects. Users are able to create company specific partner lists, project lists, previously contacted lists and manage data update requests on an annual (or selected periodic) basis, thus creating a community of known partners, while still having the ability to search the global database for new relationships in unknown markets or with unknown partners. Users then have a choice to continue to distribute key data to requesting contacts or deny an update at any point.

Current solutions focus on gathering basic data for underwriting partner qualifications. Those systems are fragmented in information requested and are limited to system users (both internally and externally). The current market solutions focus does not allow for: global access to all users (both internally and externally), select distribution, invitation, management, trending and rating and global integration of cleansed data for potential client relationships. In a system consistent with the present disclosure a social interaction concept is provided. Users are able to manage specific qualifications, notifications and communications to seek out and select relationships. Additionally, by defining access rights to internal users, administrative requirements to gather unique qualification data is significantly reduced. System administrators are able to define access rights to: Marketing, Finance, Risk Management, Project Management, Underwriting, Ownership, Logistics, Credit, Acquisition, etc. and users are now be able to communicate with firms directly within the this platforms universe. Inbox communications, folder management, home page view will all default to a basic view which can be manipulated to reflect each users or companies specific requirements. Data and initiation requests are driven by the end user as opposed to a “top-down” requirements based model.

Vendors and subcontractors are also demanding to understand financial and operational capabilities of: vendors, suppliers, owners, general contractors, construction managers, banks, insurance firms . . . all members, big or small, to complete all aspects of their profile—thus allowing users to understand that information is available. This allows for a consistent, open exchange of information in one centralized, secure location.

In general, one embodiment of a system consistent with the present disclosure includes: a communication port; a web server connected to the communication port; a database containing a plurality of records; a database server connected to the database for operating on said database; a database connectivity engine connected to the web server for preprocessing the output of the web server and connected to the database server; a queue watcher coupled to said database server for queuing incoming and outgoing e-mails and notifications; a mail server operatively connected to the communication port to receive incoming e-mails, and connected to said queue watcher to transmit outgoing e-mail and communications; a parser connected to the mail server to process incoming e-mails and communication of internal data connected to the database server; and a database server which is responsive to the parser processing to manipulate a communication record in the database, and selected ones of said plurality of records are linked to selected other ones of said plurality of records by a confirmed defined relationship or a denied defined relationship for providing user selected data.

Under software control, users are able to access, integrate and distribute sensitive information needed to secure work and maintain qualified status with key partners. This collaborative solution may be integrated into pre-existing qualification, solicitation, regulatory and partner defined platforms. As an open source solution, users are able to access their account information wherever they can get on to the internet using any number of hardware devices: desktop, laptop, smart-phone or tablet. Additionally, since the system utilizes secure servers to store and maintain the data, users will not use any additional storage for management and maintenance of the secure data.

The networking database has a plurality of records corresponding to construction related companies. In the networking database the records of registered individuals are linked by a user selected, defined relationships to a record of one or more other individuals. This addresses the need for a centralized dedicated open market qualification and data distribution solution for the construction marketplace. Users have the ability to: access a comprehensive database of construction and construction related businesses, invite and distribute sensitive data in a user selected means, communicate directly through the system, maintain, manage and trend data, maintain groupings and folders based on specific defined criteria, receive and manage alerts based on user defined criteria.

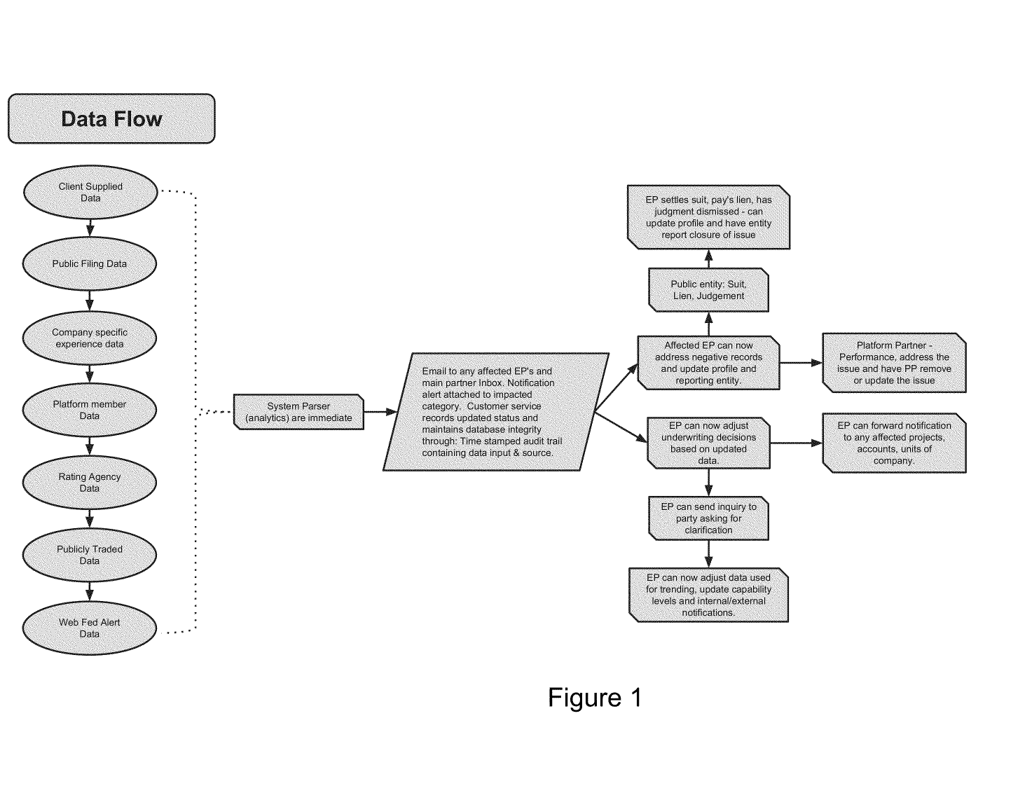

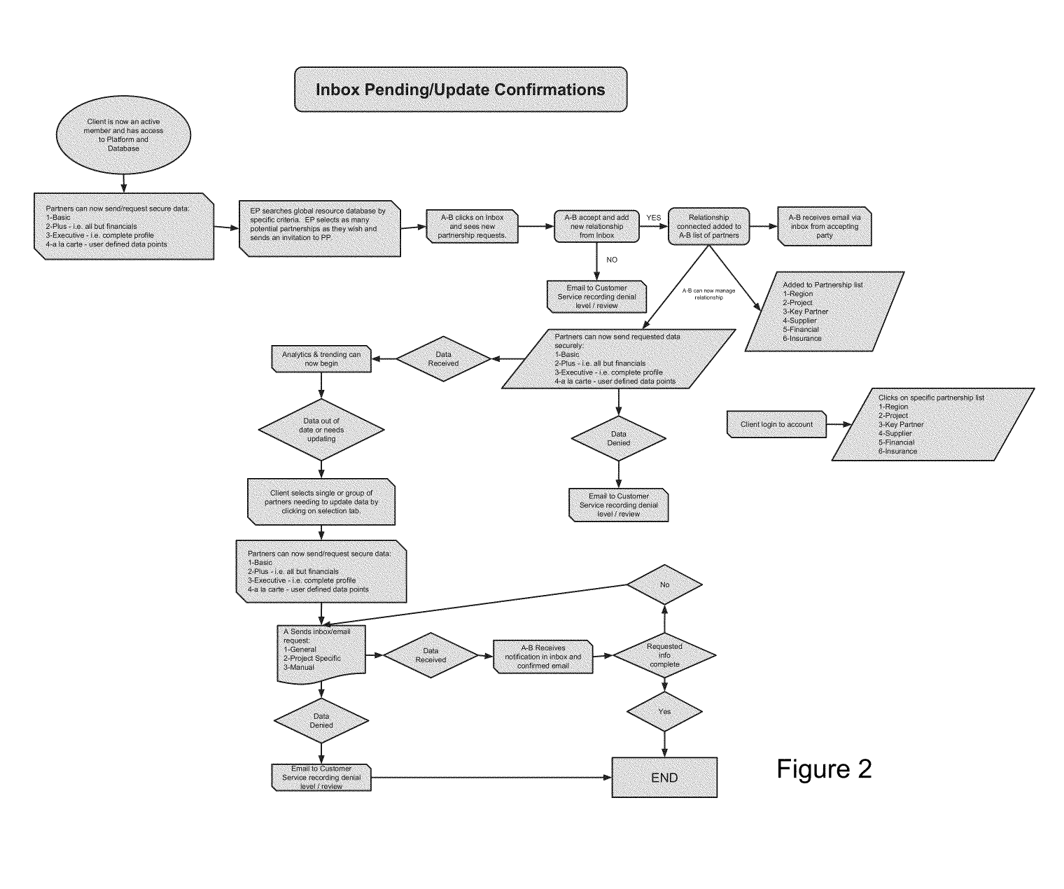

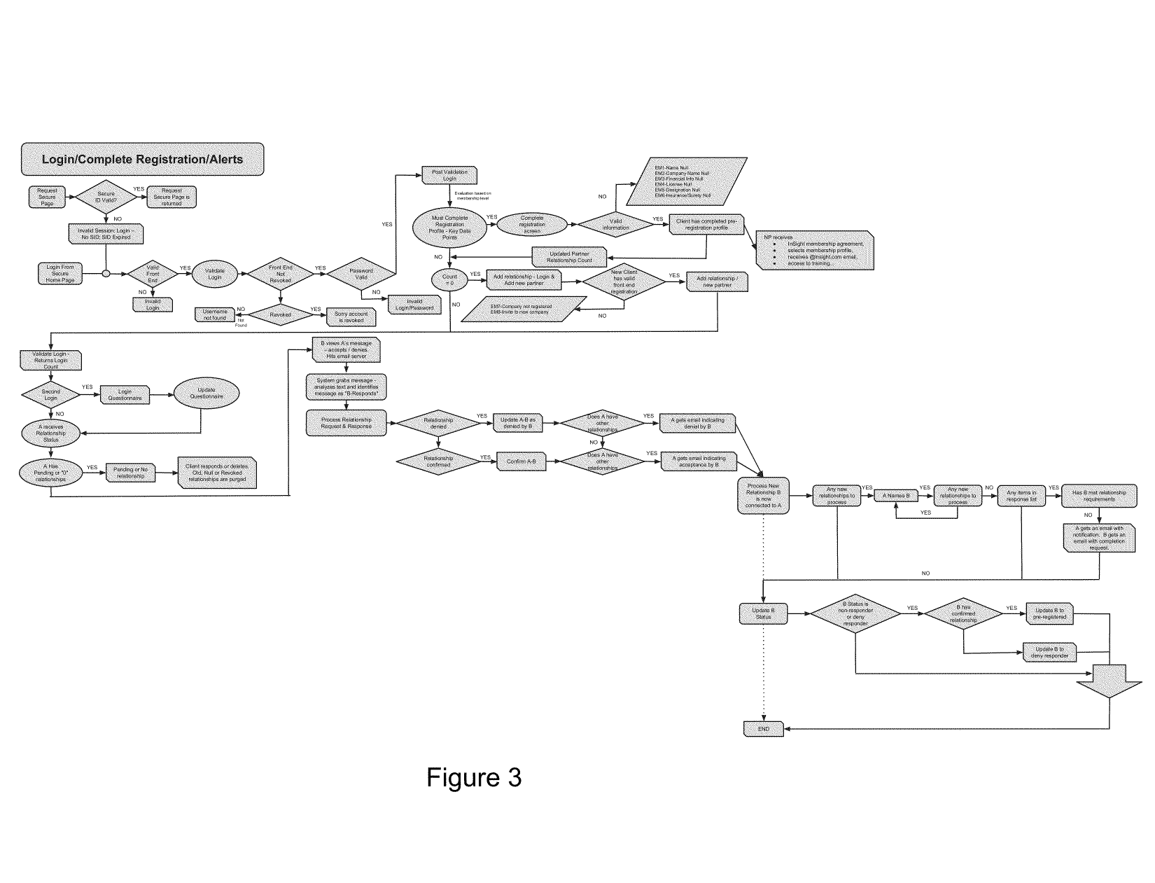

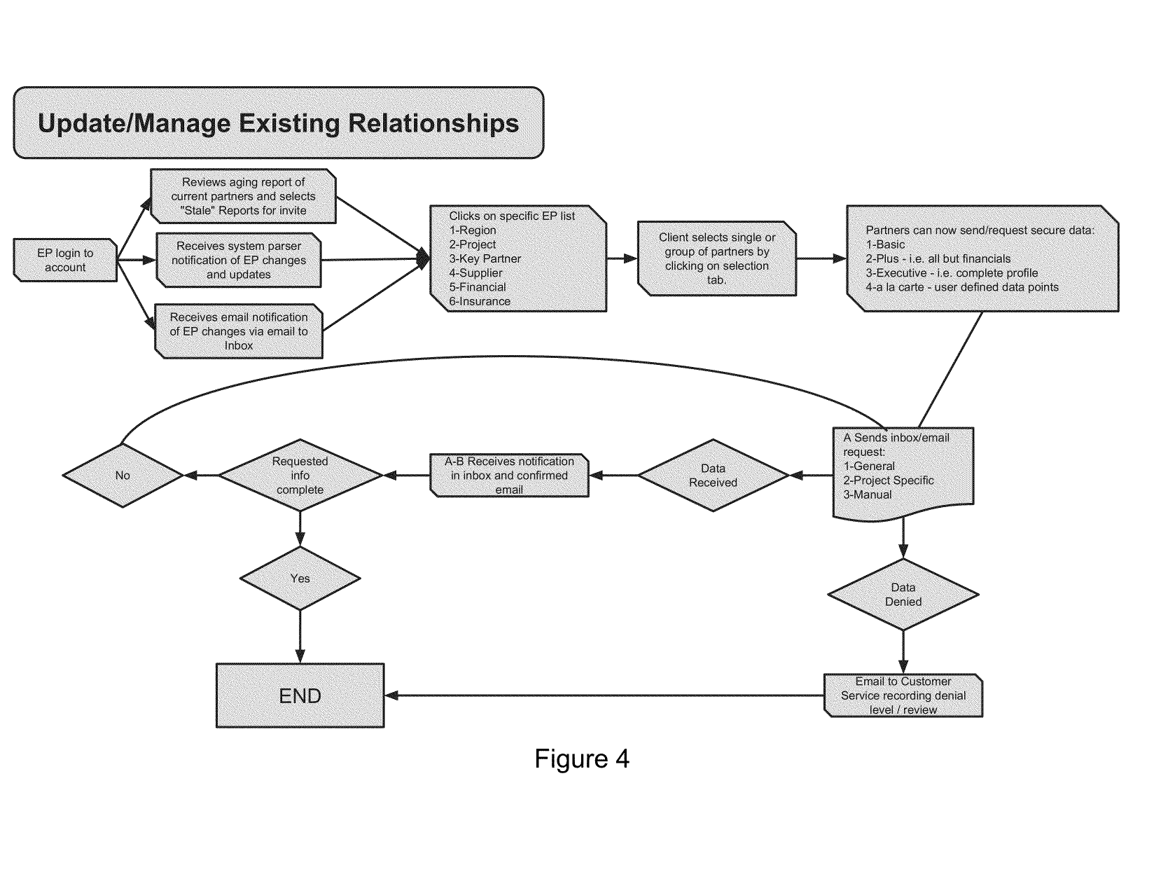

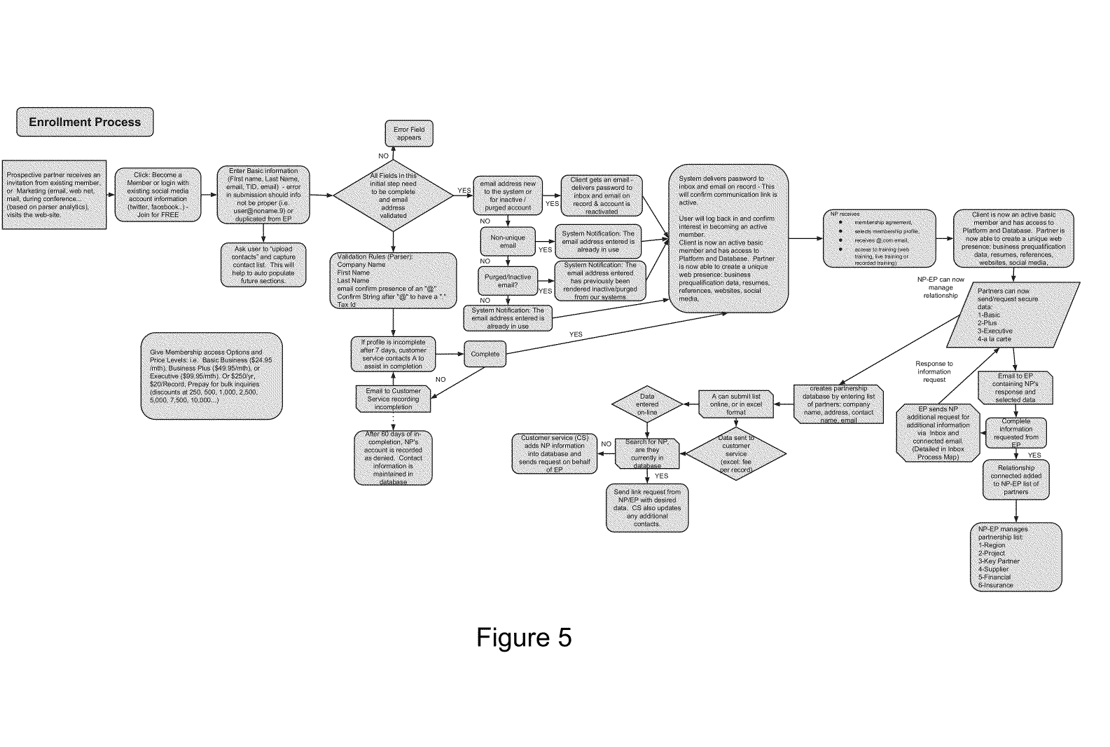

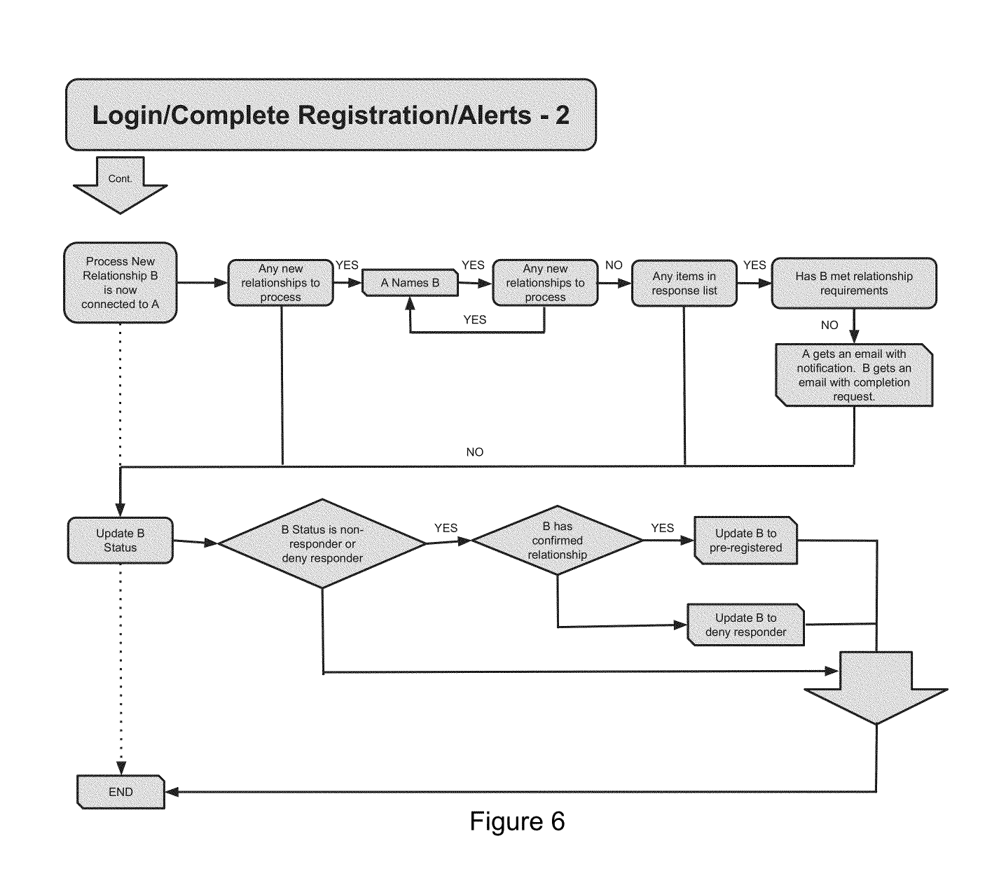

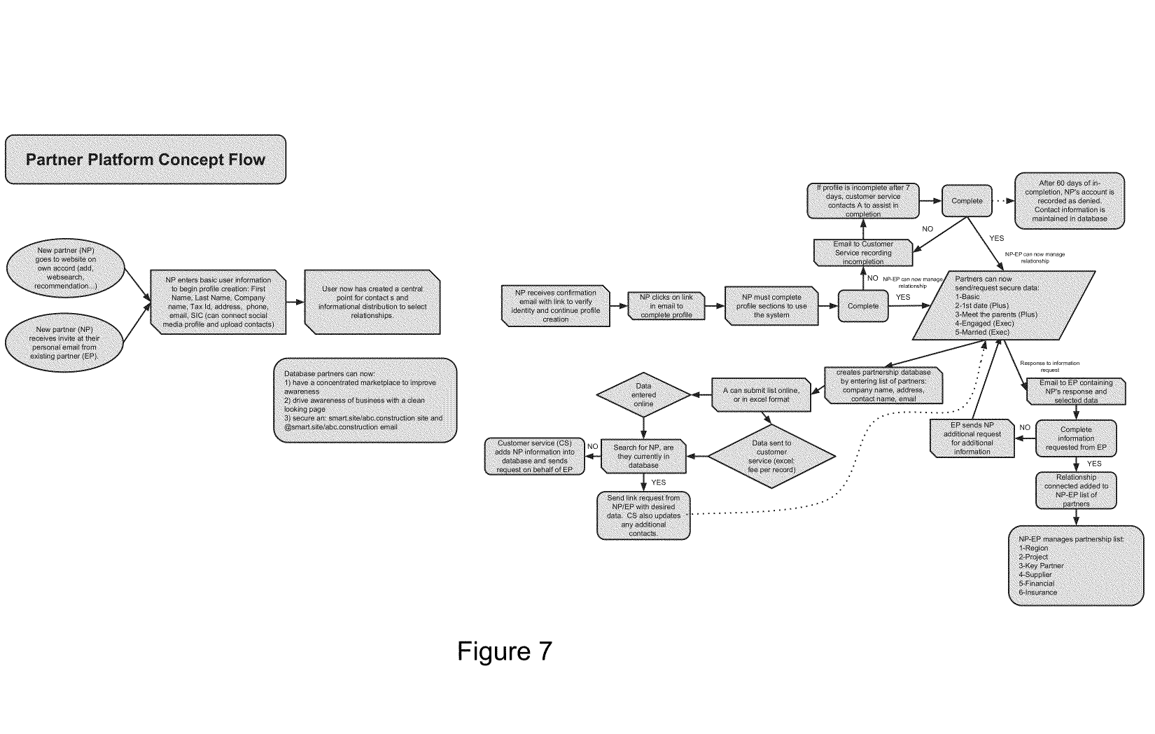

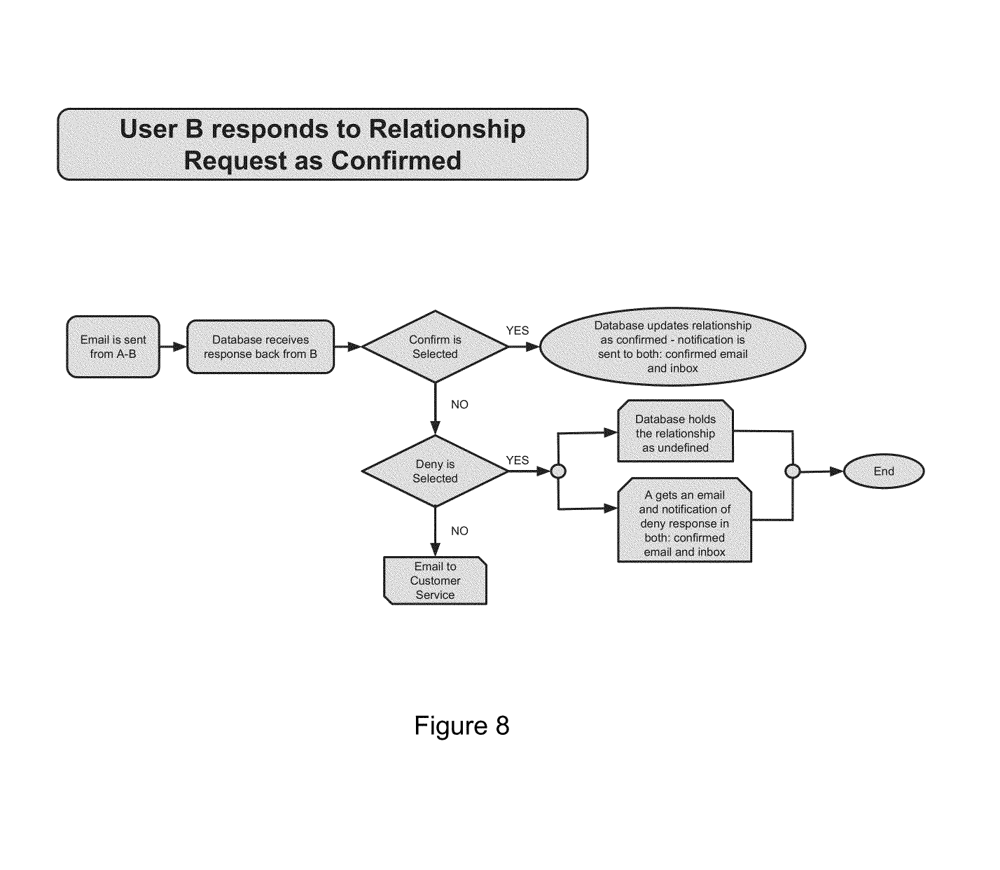

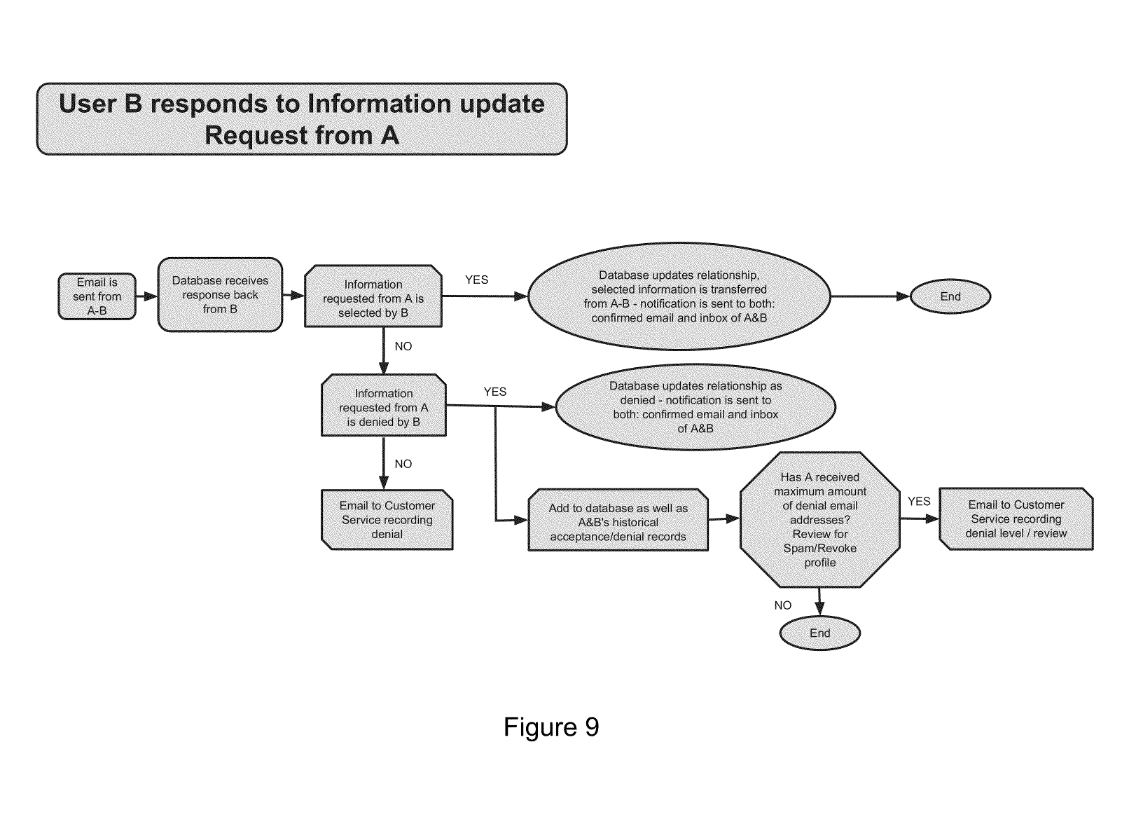

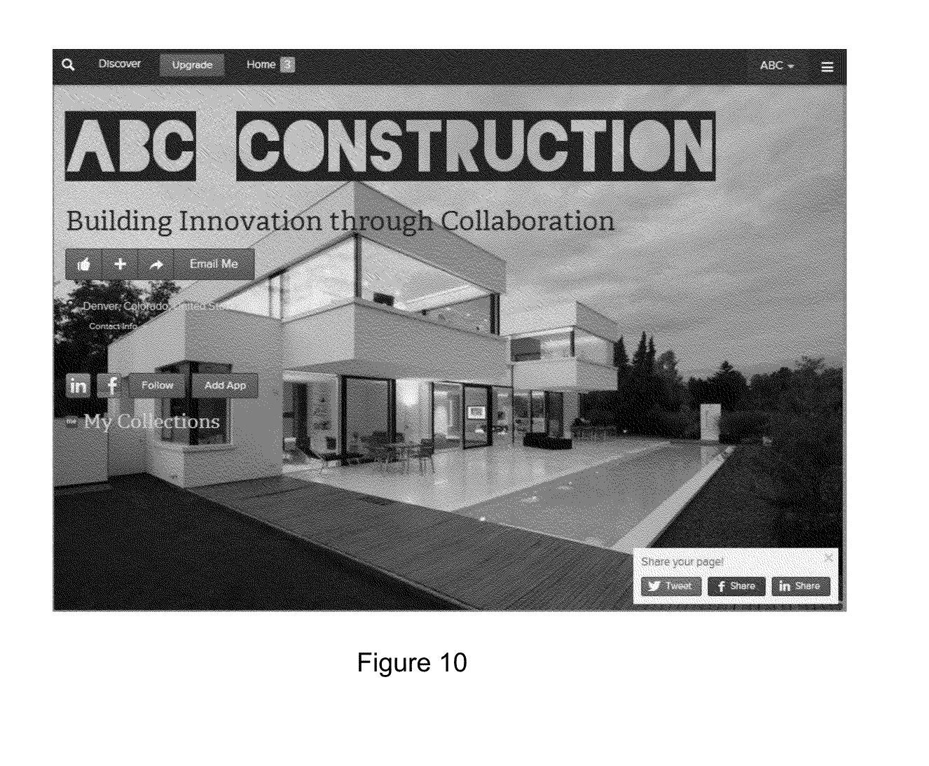

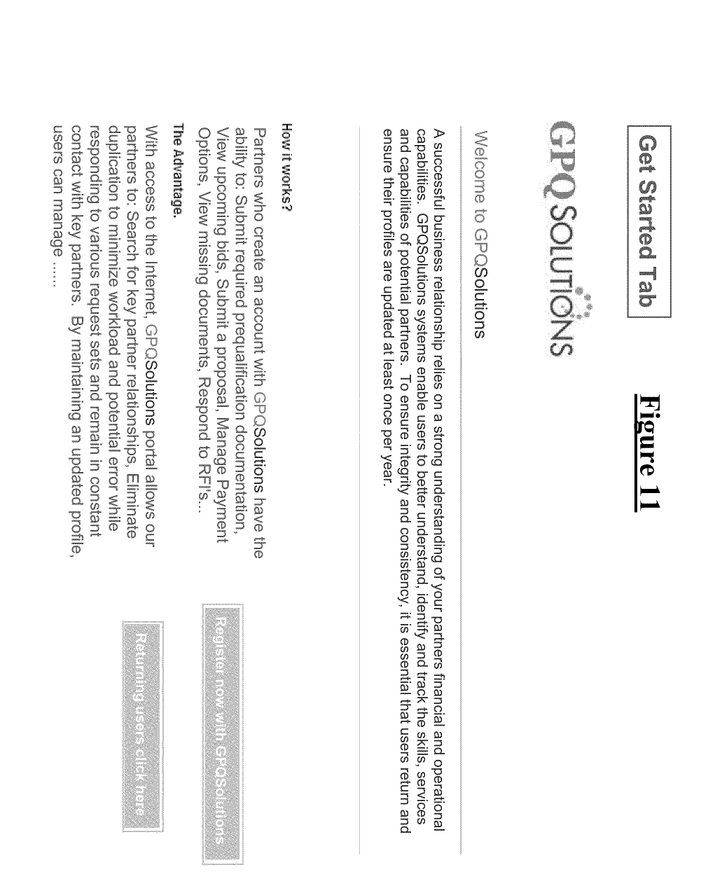

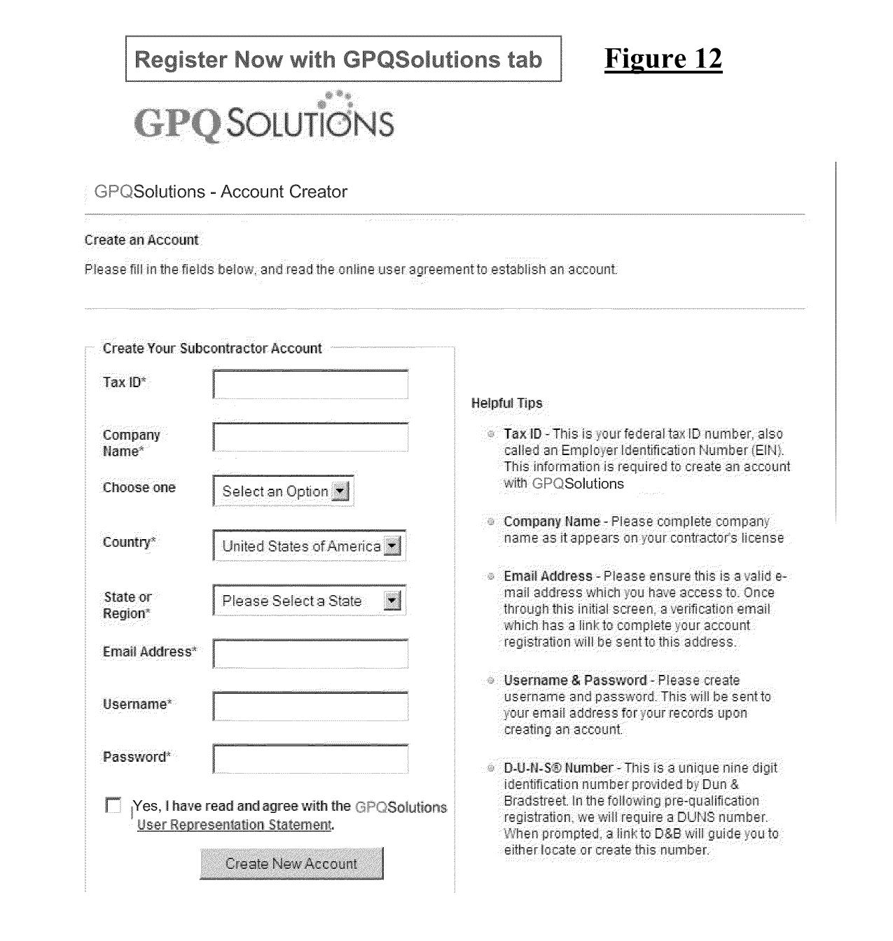

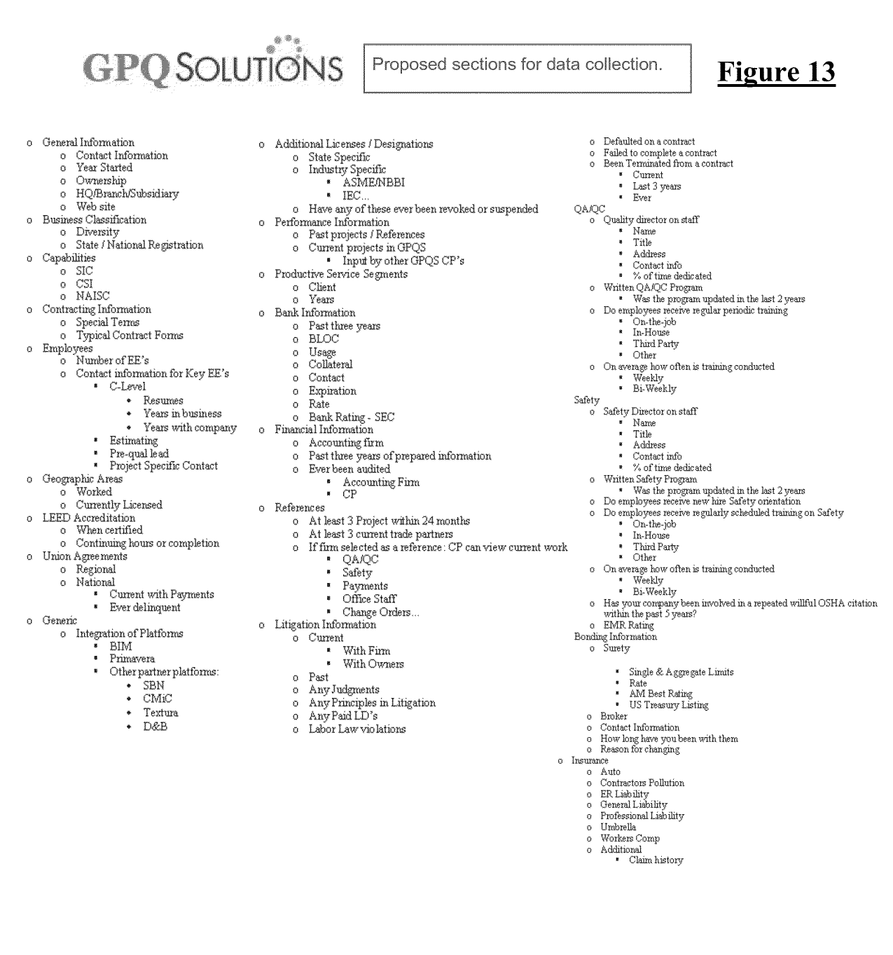

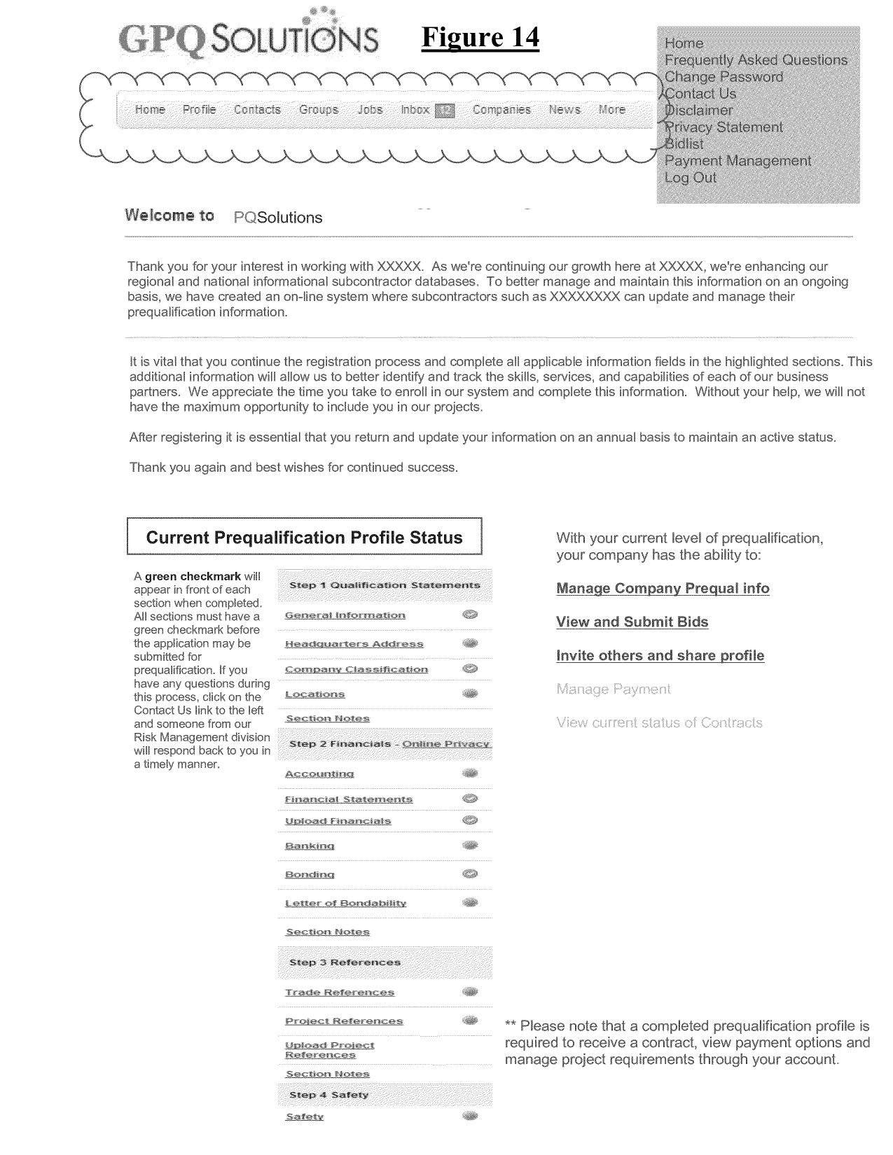

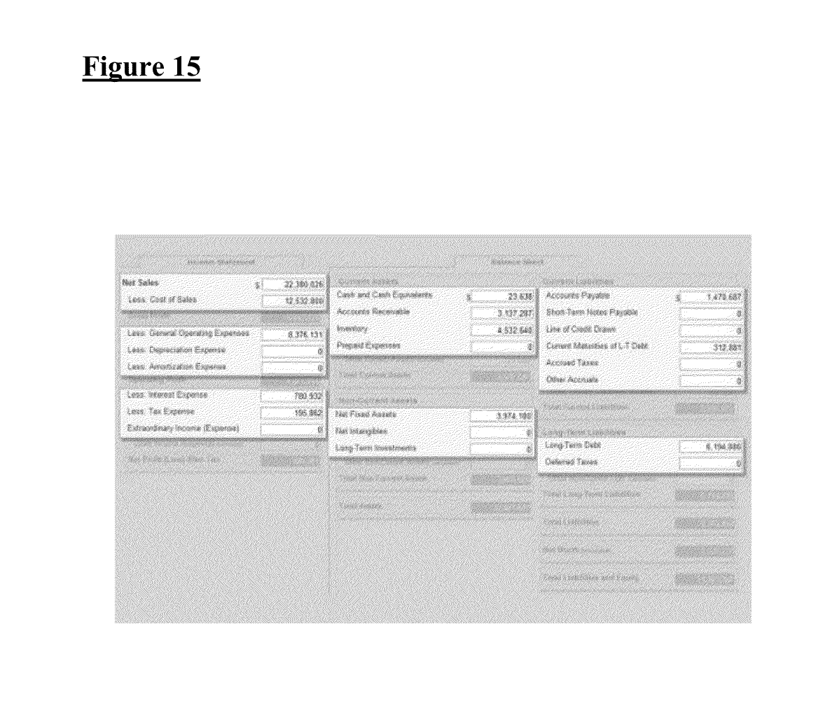

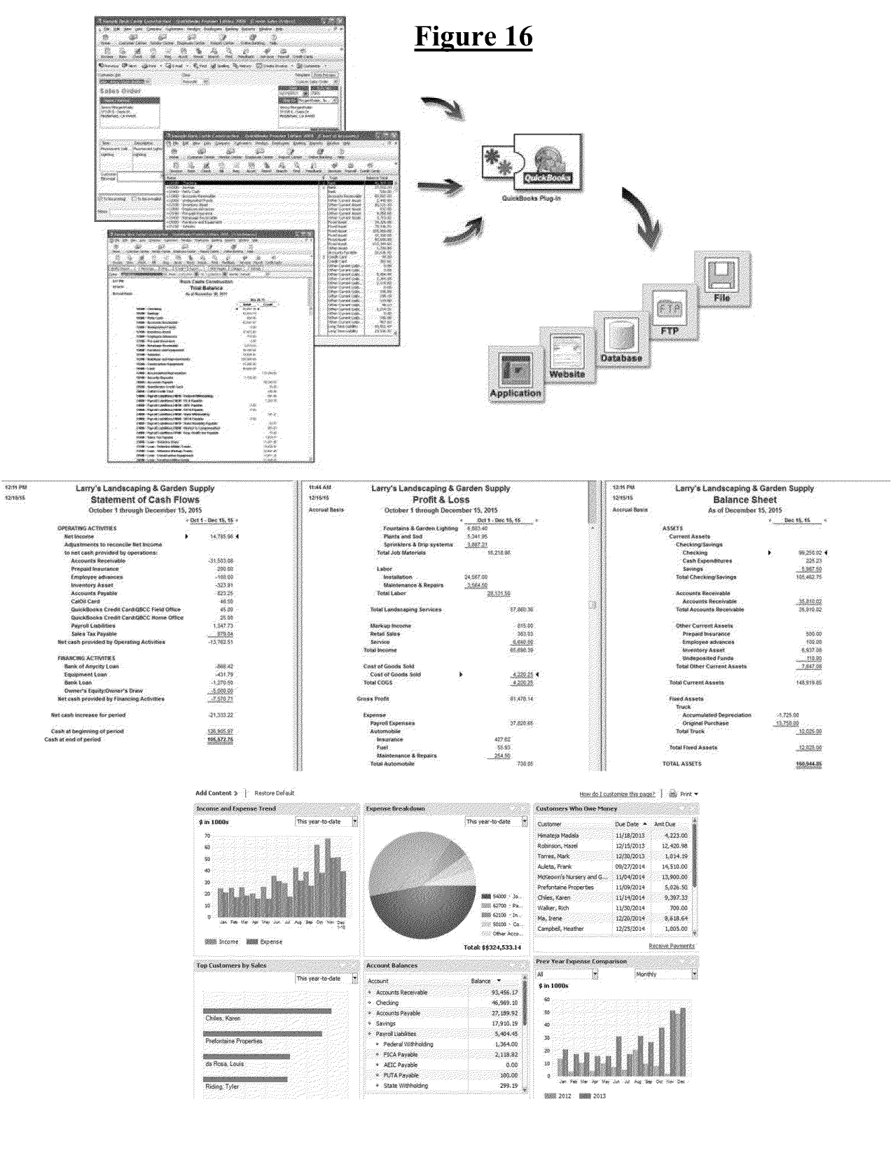

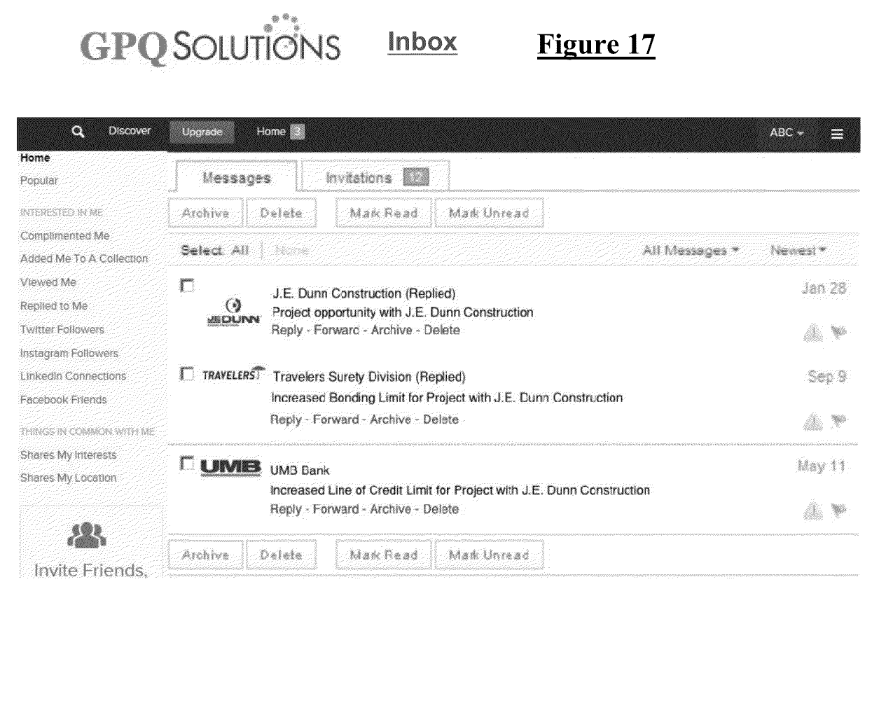

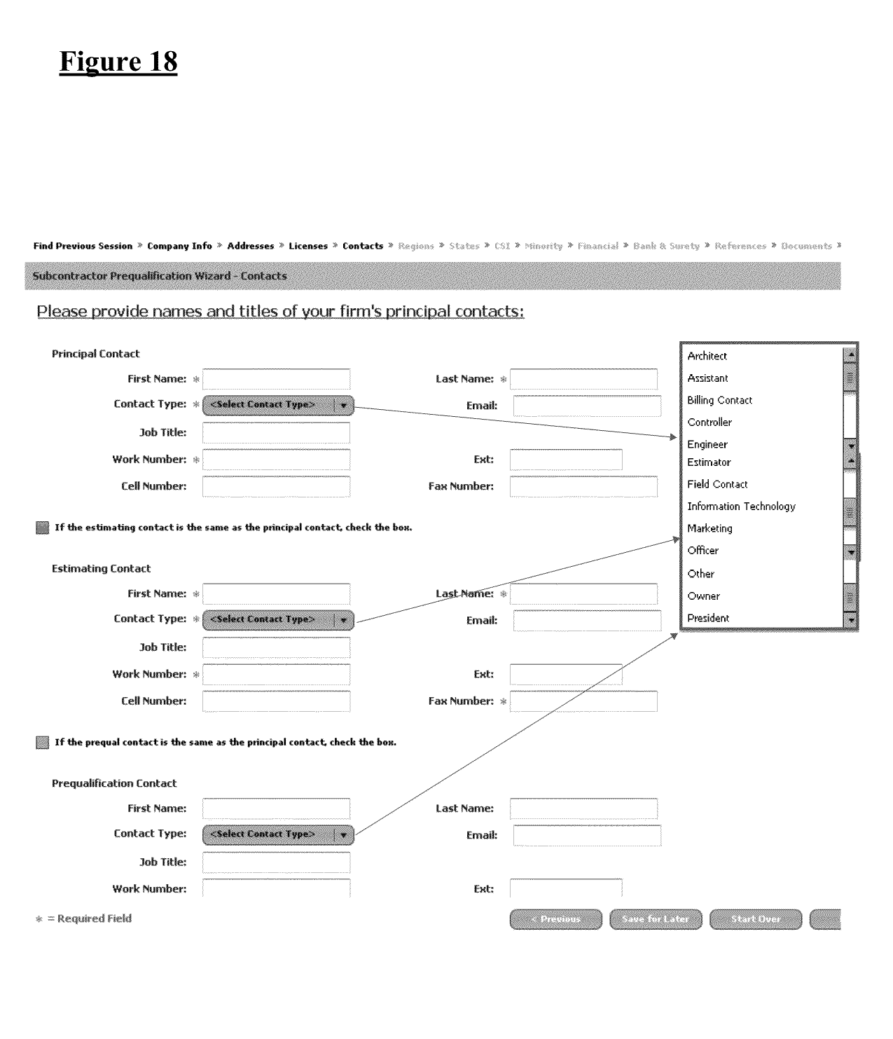

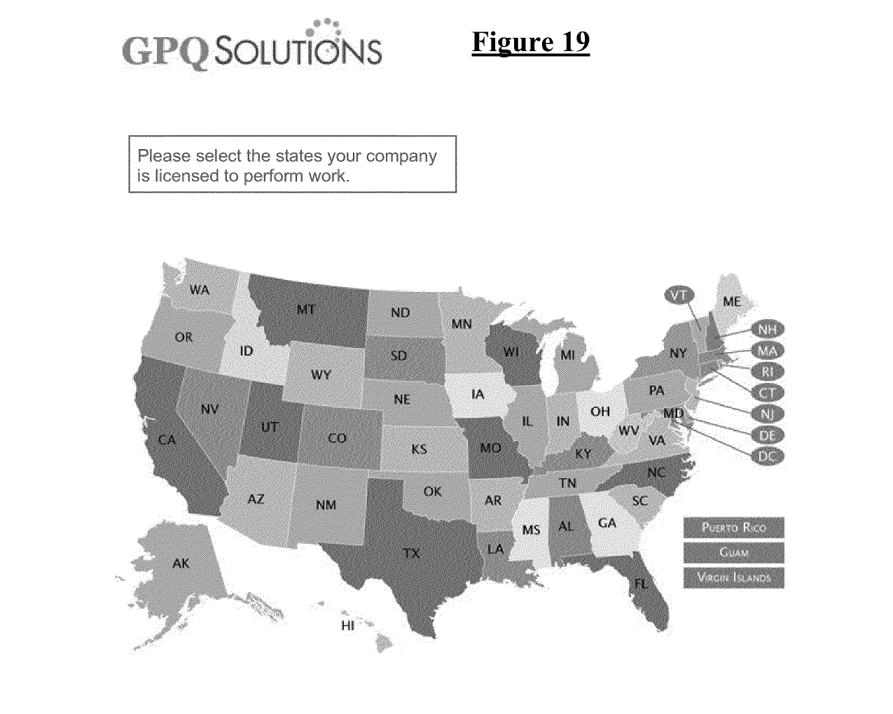

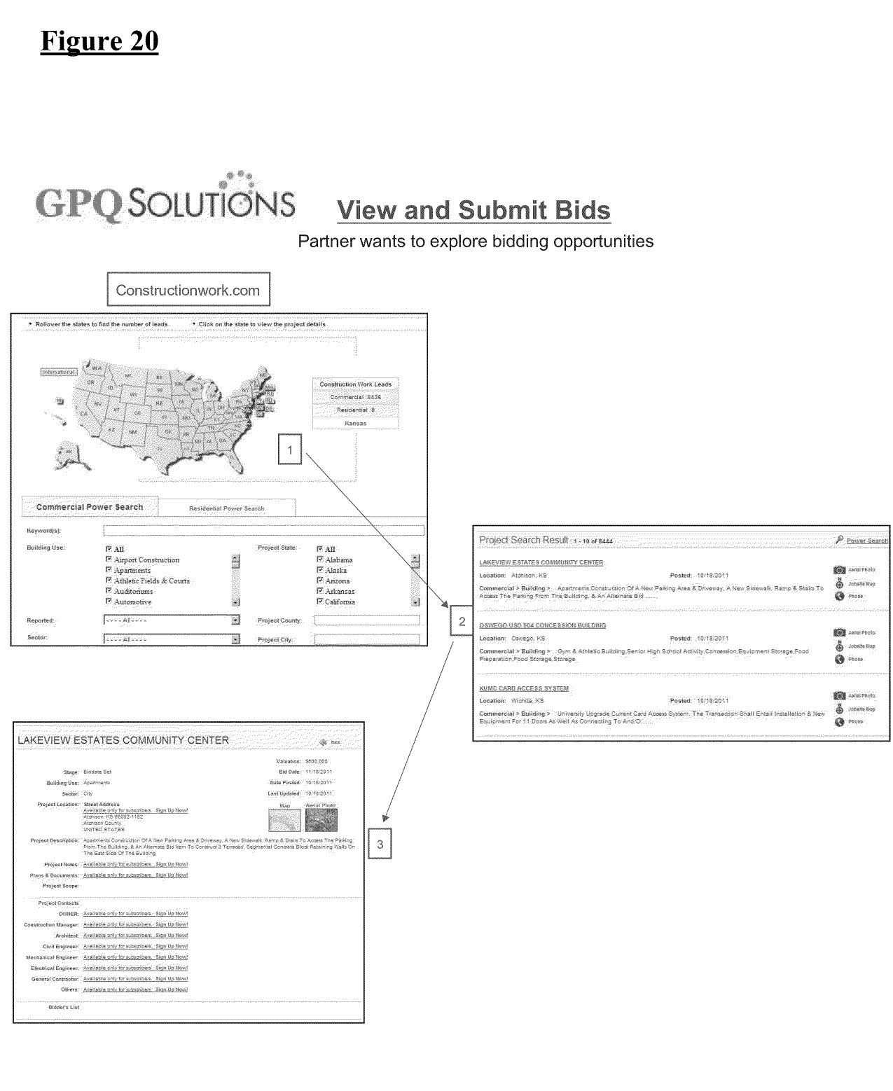

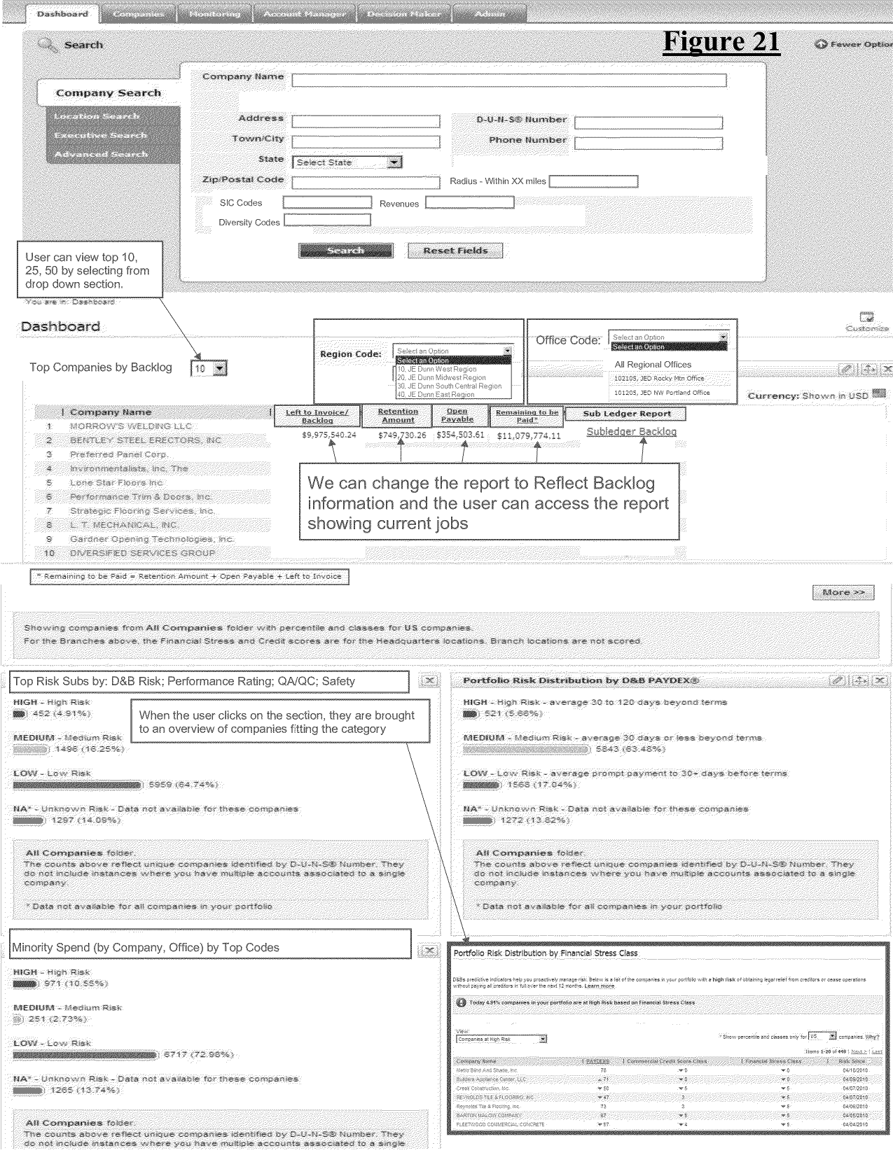

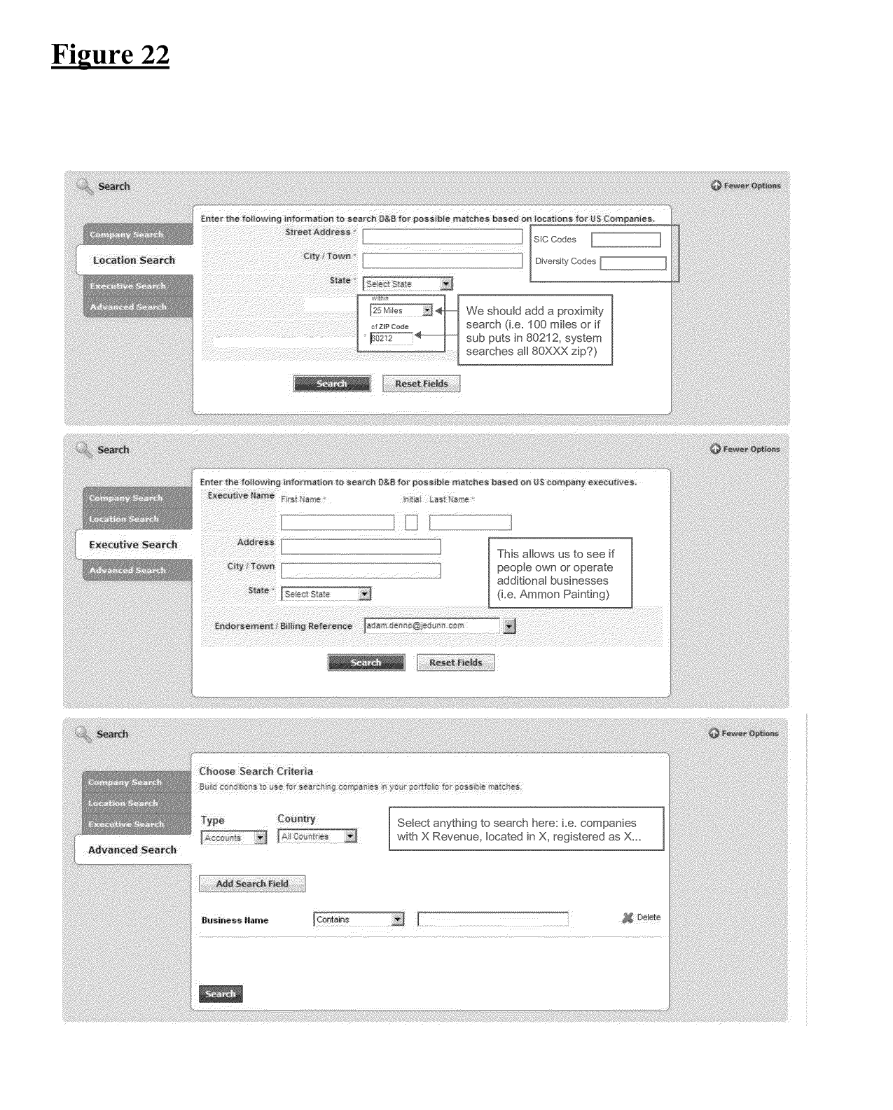

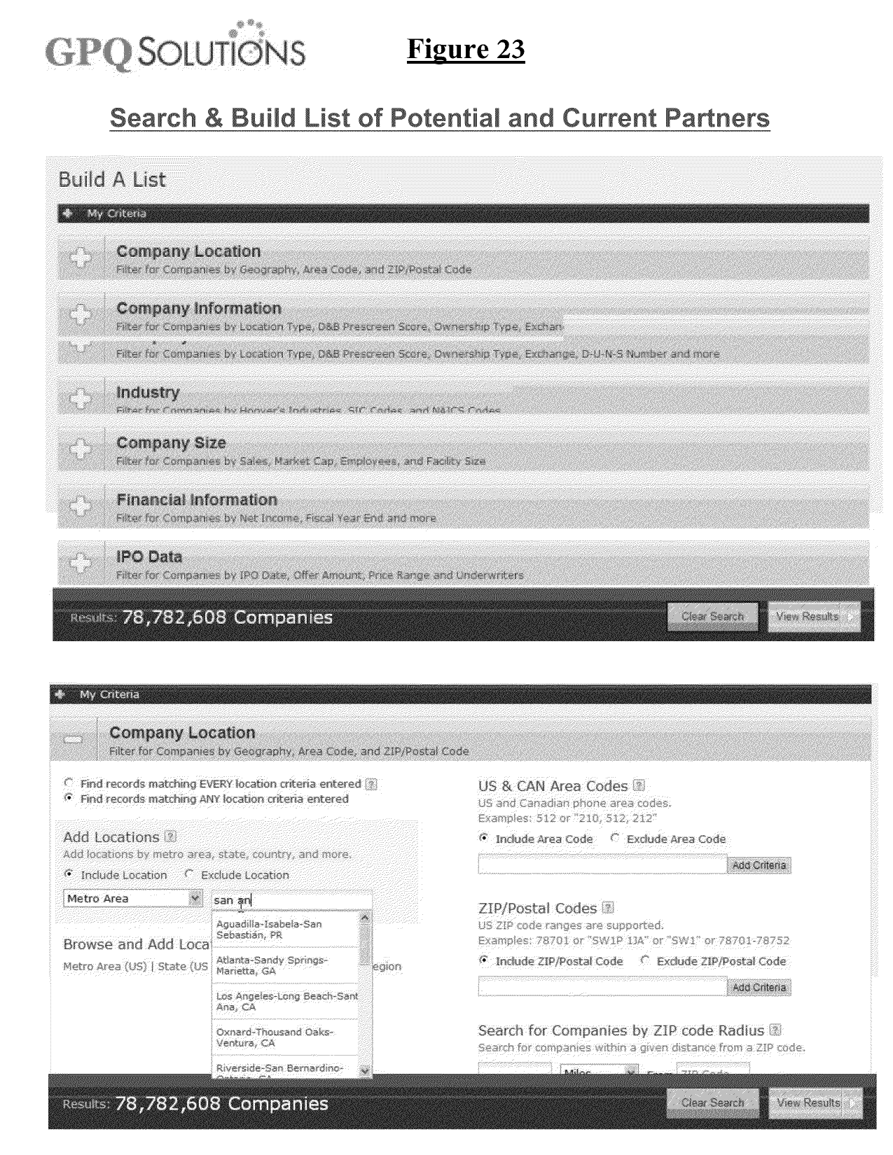

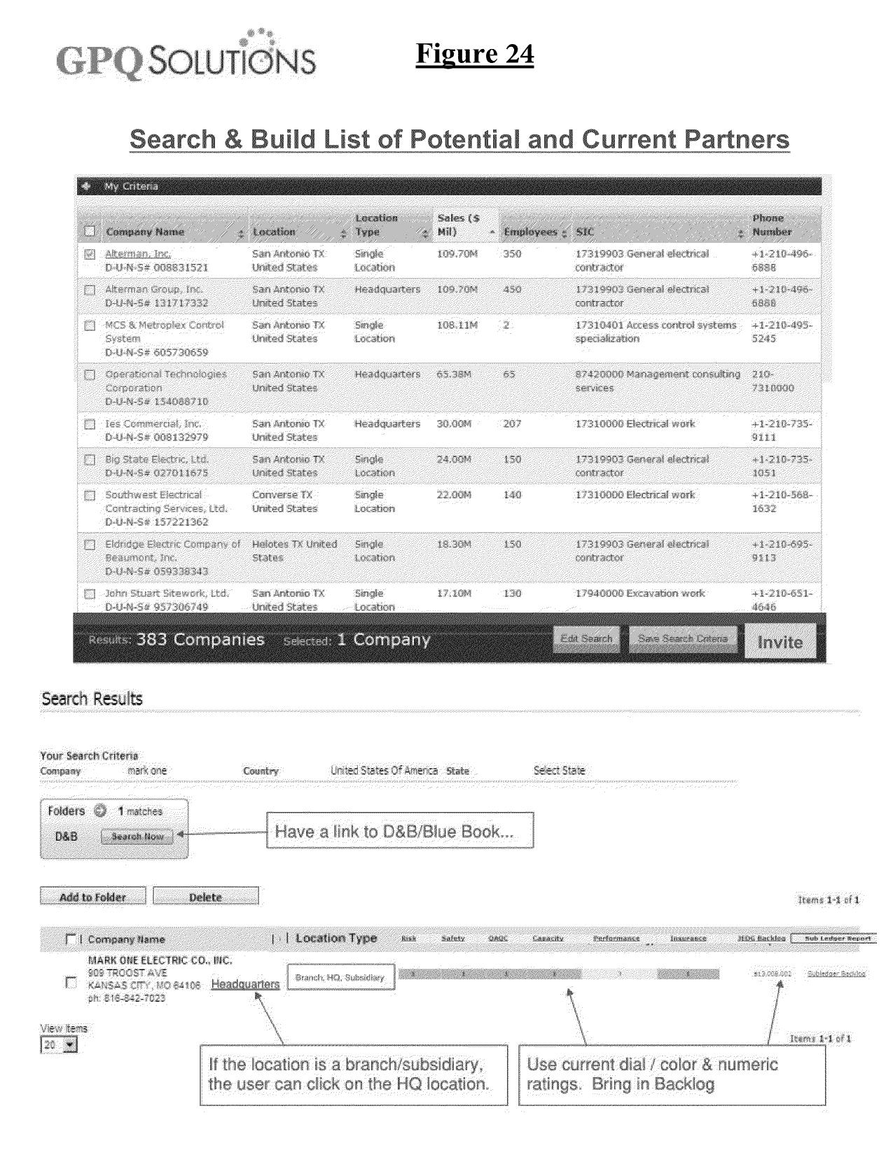

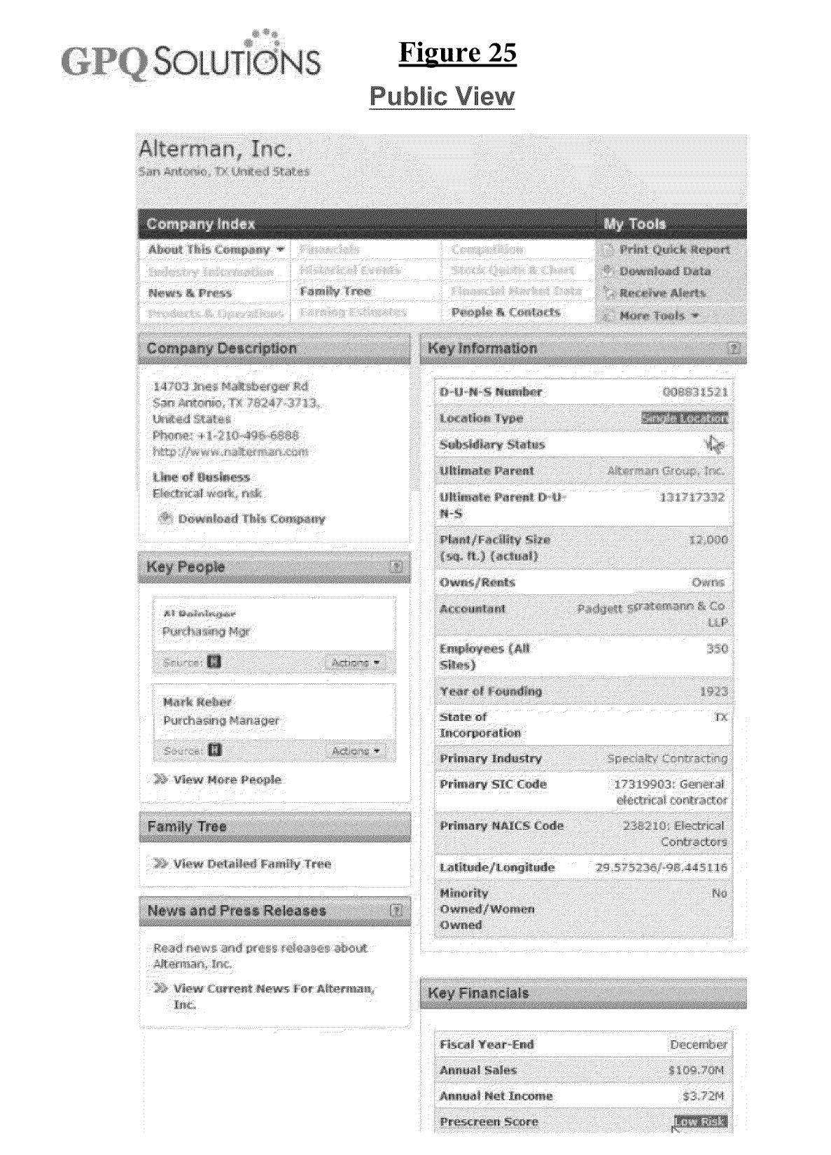

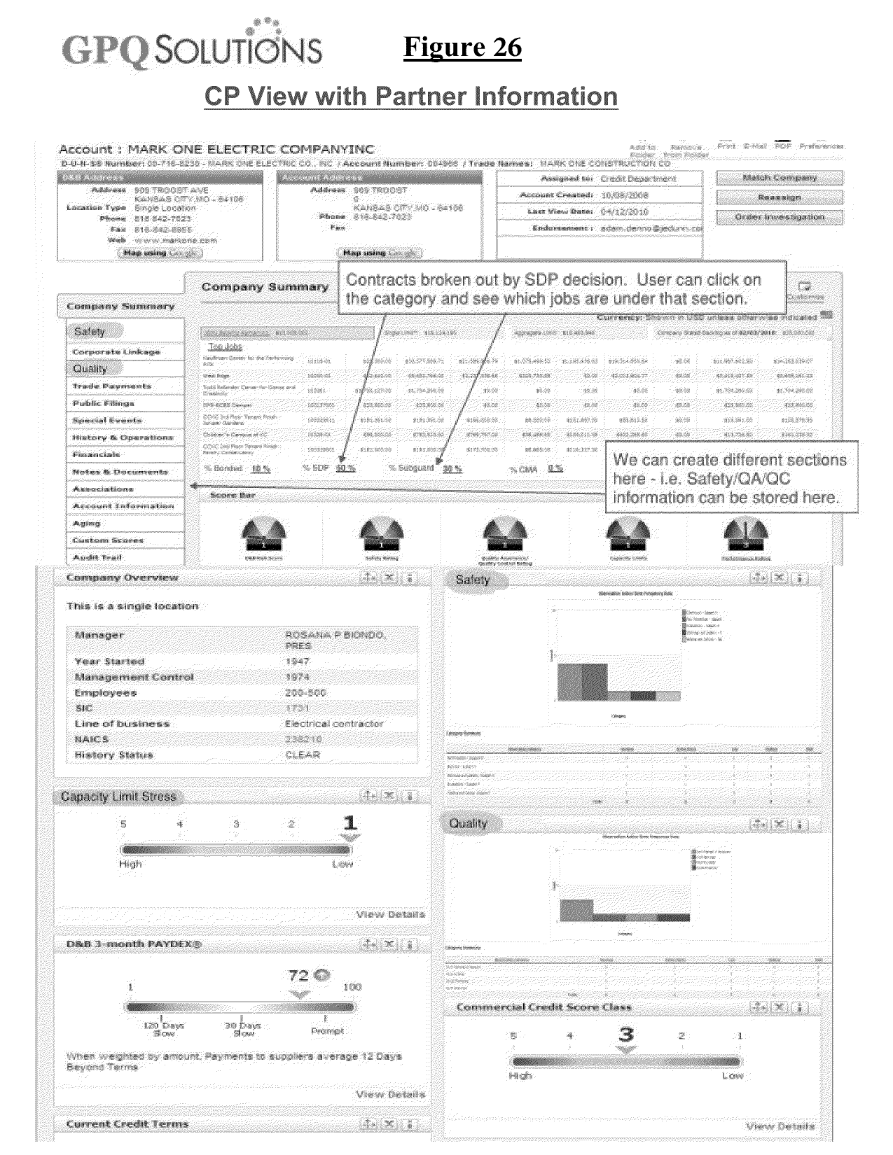

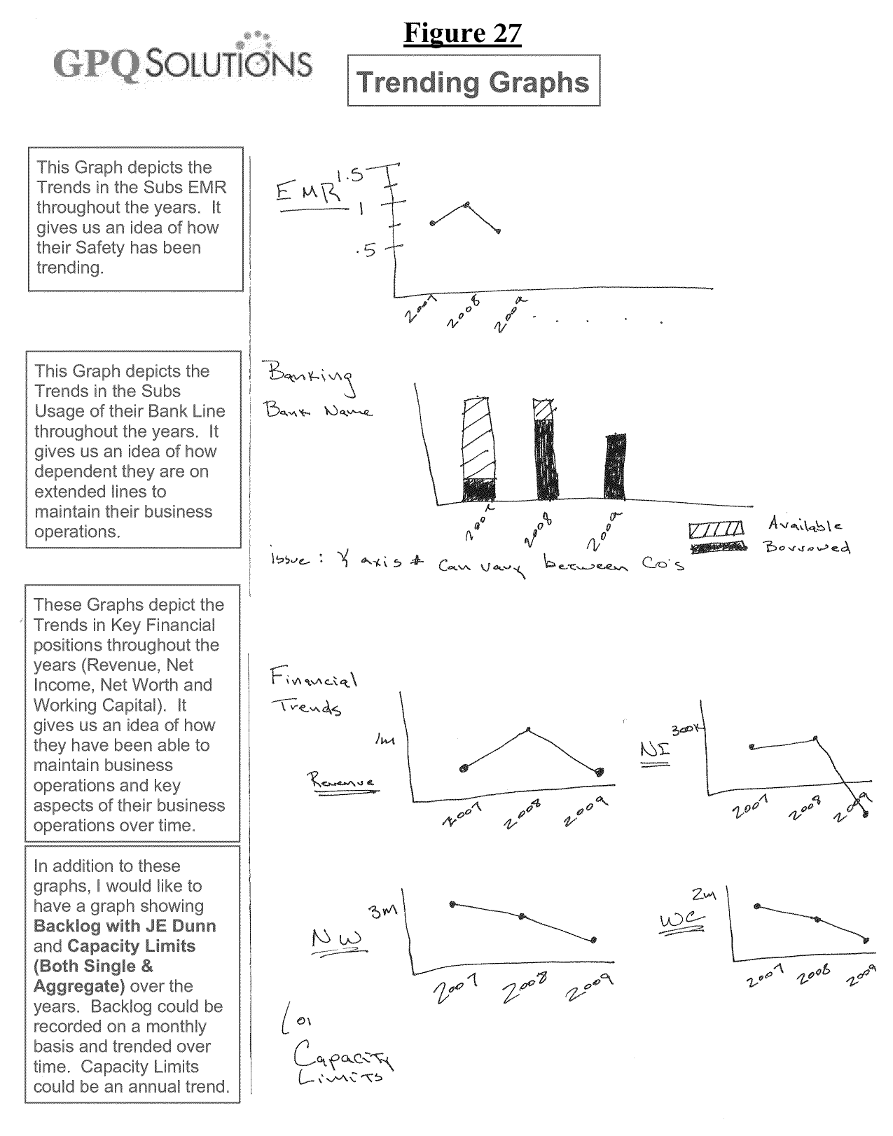

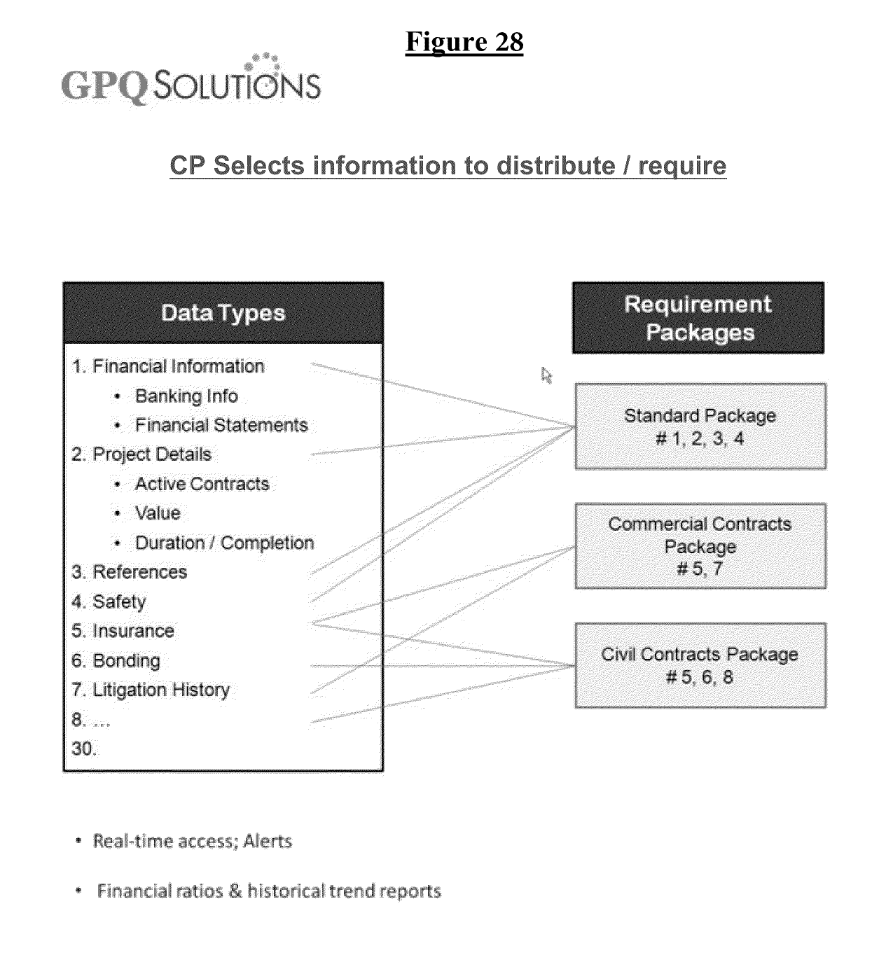

Flow charts and exemplary screen shots consistent with embodiments of the present disclosure are attached hereto. FIGS. 1-9 and 16 depict flow charts showing example embodiments consistent with the present disclosure. FIGS. 10-15 and 17-26 show example graphical user interfaces for implementing a system and method consistent with the present disclosure. FIG. 27 depicts an example of output from data analysis tools and FIG. 28 depicts an example method for packaging information consistent with the present disclosure.

In the illustrated exemplary embodiment, a user receives an invite from an existing member or log in to create a profile. Once the user initially logs into the site they are be directed to complete an “Insight” profile. This profile is comprehensive in nature consisting of basic, public and sensitive data. Once fully completed, the user gains access to the site. There, the user can: send all, a portion, or a specifically selected level of data for public view or to a specifically selected partner or partners to view. The user can also: post project opportunities; seek out key business relationships; follow industry or specific interest news feeds and manage their profile on an annual (or less) basis.

Users are also allowed to add internal users and allow certain levels of access to those specific users. This allows different business specialties to manage and distribute key information without requiring a redundant process. This is a unique feature as most underwriting platforms in the market focus on external access; Insight also allows focus on internal access. Business functions such as business development can now gain access to and manage data which is required from owners detailing a firms qualifications, finance representatives will have access to certain information needed to update and submit key information to clients, banks, insurance and accounting partners, risk management will have access to certain information needed to send out regarding surety or default information, operations members will have access to certain information needed to access current and past performance ratings on key partners, owners have access to certain information needed to communicate with key clients, joint venture partners and other key partners to maintain a current level of prequalification with them.

Beyond the invite, selective distribution, management and maintenance of sensitive data, other embodiments may allow for users to ensure the data submitted is current and accurate. Users may be required to update the key data in one centralized location, e.g. once per year, which enables our users to ensure a higher degree of accuracy and oversight. Insight may also continue to communicate with users on the accuracy and current timeliness of information (via standard computations and date driven criteria) through inbox notifications and color coding of data (i.e. green: 0-4 months, yellow: 4-8 months, red 8-12 months since last update)

Once a profile is completed, e.g. as directed by the illustrated screen shots, a member of the platform is be able to invite other members as well as non-members to view their information. When a member is invited they are able to view and manage the request through an inbox or user defined folder. This allows each of the parties to monitor and manage responses, project experiences, key data and performance trends. Once a member is linked to another member, each party will receive system notifications of data updates, performance updates and user selected information. Users can also set internal notifications which will signify selected internal users when data needs updating or something is reported on the company. This allows the member to respond or manage any issues.

Thus, members access the system via an on-line platform. Once there, members may be required to complete a comprehensive profile consisting of: organizational, financial, operational, historical, banking, bonding and insurance data. Each profile, once completed may have a minimum of 16 other contacts entered in as key relationships.

The method of the present invention is directed to constructing a networking and open forum for sharing user requested and selected data. This is accomplished through a comprehensive database consisting of a first user sponsor and a second user invitee, using a first defined relationship, wherein the second user confirms the sponsored defined relationship. The confirmation of a defined relationship renders the second user a member of the Insight database as well as the first user sponsor specific group. Thus, a link is established between the first and second users. In this manner, by each sponsored user confirming the original sponsored defined relationship and in turn sponsoring one or more other users, the database grows in size, geometrically, or exponentially.

In the illustrated embodiment, the method of constructing the database concerns issuing an e-mail invite from a database service provider to a first individual. The individual is invited to respond to the delivered e-mail by enrolling into Insight and providing selected information. The information may include, again: organizational, financial, operational, historical, banking, bonding and insurance data, that the first individual is interested in learning. The database service provider scans the incoming data from the second individual, extracts from the e-mail profiles contained in the new profile and then generates and transmits an e-mail message inviting the subsequent individuals to join the database.

The second individual is thus a new member in the system and can now invite others to join their network of business partners and respond by providing information about them, and perhaps by providing selected information regarding additional individuals. At any point, the invited individual may confirm or deny the relationship with the first individual. In addition perhaps, the second individual may modify the relationship type as proposed by the first individual.

In the case that the second individual confirms the relationship with the first individual, this confirmation creates a defined relationship between the first and second individuals. This information is stored in the database, in records respectively associated with the first and second individuals. Similarly, if a third individual confirms or denies a relationship with the second individual, this information also is stored in the relationship database. A registered member who completes all of the membership requirements is known as an “active” member. Importantly, in this embodiment, the messaging is entirely electronic, that is, by e-mail. It is, thus, automatic and a database can be quickly constructed.

In the foregoing manner, numerous individuals can become members of the database, each member having a defined relationship to one or many other members.

In addition to the e-mail communication system for joining the database, individuals also may join the database by accessing a website of the database service provider on the Internet, e.g. as shown in the illustrated screen shots in FIGS. 10-15 and 17-26. As shown, this may be done in a conventional manner by accessing the Web-site through an Internet service provider. Once the user has logged into the website, he can input certain information and request other individuals to become members, thereby beginning the registration process. Each individual who is an active member will have the opportunity to provide additional information regarding personal characteristics. This information also becomes part of the database associated with the individual. This information is preferably input, and thus can be edited, via the Web site of the database service provider.

The first individual inviting a second individual, via the website, causes an e-mail message to be automatically generated and delivered to the second individual. This e-mail message prompts the second individual to respond by e-mail in the manner as previously described. The second individual may respond by e-mail as previously described, or alternatively, may access the website to find out more information regarding the database service provider, and proceed with the registration process through the website instead of the e-mail communications technique.

In this way, the database can become constructed automatically, based on information which is entered electronically. Moreover, the growth of the database can become exponential as more and more members sign up additional members who in turn sign up an additional number of members. Thus, it is not inconceivable that the database can contain hundreds of thousands, if not millions, of individuals, each having a record in a database, in which the individual provides selected company information. The profiles and respective files contained in the database are password protected for security and privacy reasons.

The database, thus constructed, contains defined relationships between different pairs (or groups) of individuals. As noted, these pairs of individuals can be linked or interconnected by chains of defined relationships so that one individual can access the database and, through a number of search criteria locate another individual who is also a member of the database by some characteristic (CSI code, zip code, annual revenue, minority status, union status, average project size . . . ), that is information that was input into the database. Although the searching individual may not personally know the individual who is the object of the search, the searching individual has a defined relationship with someone; the object individual can be connected through this networking to the searching individual.

Although the some embodiments consistent with the present disclosure involve the use of e-mail and the Internet based on ease of communications and automatic processing, it should be understood that alternate messaging forms could be used, for example, Skype or other internet driven video conference applications via input by dial driven communication.

The networking database of the present invention has applications for searching in terms of finding other individuals in the database, finding a connection to other users in the database, and finding other individuals in the database having particular professional characteristics or features that are of interest to another member, managing those relationships, monitoring those relationships and centralizing and streamlining the client underwriting relationship process.

According to one aspect of the present disclosure there is thus provided a qualification system including: a network database having a plurality of records corresponding to a plurality registered users wherein the plurality of records include a user profile; a registration system being capable of creating the user profile for an unregistered user, wherein the user profile identifies at least a portion of the user profile as at least one of basic, public, and sensitive; and a notification system configured to distribute a notification to at least one registered user, wherein the notification includes at least one of data updates, performance updates, and user selected information.

According to another aspect of the disclosure there is provided a qualification system including: a vendor interface configured to allow a plurality of vendors to supply pre-qualification information; and a user interface configured to allow a plurality of users to view the pre-qualification information from each of the plurality of vendors.

Exemplary operations according to embodiments are shown in the flowcharts and screen shots, it is to be understood that other embodiments of the present disclosure may include sub-combinations of the operations depicted therein and/or additional operations described herein. Thus, a system consistent with the present disclosure may be directed to all or part of the components and/or operations depicted in one or more flow charts or screen shots. In addition, there is no requirement that the operations depicted the flow charts or screen shots, or described elsewhere herein, need to occur in the order presented, unless stated otherwise.

Also, the illustrated and/or described sequence of steps in merely provides an example of how the general functionality described herein can be implemented. The steps do not have to be executed in the order presented unless otherwise indicated. In addition, it is to be understood that other embodiments consistent with the present disclosure may include sub-combinations of the illustrated steps and/or additional steps described herein. Thus, claims presented herein may be directed to all or part of the components and/or operations depicted in one or more flow charts or screen shots.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A qualification system comprising:
a network database having a plurality of records corresponding to a plurality registered users wherein the plurality of records include a user profile;
a registration system being capable of creating the user profile for an unregistered user, wherein the user profile identifies at least a portion of the user profile as at least one of basic, public, and sensitive; and
a notification system configured to distribute a notification to at least one registered user, wherein the notification includes at least one of data updates, performance updates, and user selected information.

2. A qualification system comprising:
a vendor interface configured to allow a plurality of vendors to supply pre-qualification information; and
a user interface configured to allow a plurality of users to view the pre-qualification information from each of the plurality of vendors.
